(19) United States
(12) Patent Application Publication
(10) Pub. No.: US 2012/0036138 A1
(43) Pub. Date: Feb. 9, 2012

(54) METHOD AND APPARATUS FOR DESIGN SPACE EXPLORATION IN HIGH LEVEL SYNTHESIS

(75) Inventor: Benjamin Schafer Carrion, Tokyo (JP)

(73) Assignee: NEC CORPORATION, Tokyo (JP)

(21) Appl. No.: 13/260,302

(22) PCT Filed: Mar. 31, 2009
(86) PCT No.: PCT/JP2009/057043

§ 371 Date: Sep. 24, 2011

(51) Int. Cl. G06F 17/30

(52) U.S. Cl. 707/748; 707/E17.084

(57) ABSTRACT

A method for automatically exploring a design space of an untimed high level language, comprising at least one of: (a) exploring automatically a set of local operations parsing an input source and assigning a set of attributes to each of the local operations; (b) exploring a set of global synthesis option that affects an entire design of a target circuit; and (c) exploring number and type of functional units allocated to the design.

### TECHNICAL FIELD

The invention relates to methods, systems, and program products related to electronic design automation (EDA) and particularly to circuit design for the automated microarchitectural exploration of the design space of high level languages in high level synthesis, which is sometimes referred as behavioral synthesis.

### BACKGROUND ART

System designers typically deliver a specification of the planned hardware design in a high level language, e.g. C or C++. This allows an easy and fast way to estimate system performance and verify the functional correctness of the design. Describing the hardware design in the high level language offers higher levels of abstraction, which helps also for the re-usability of the code. It also offers faster simulations and the possibility to use all the legacy code and libraries existing for that high level language. Hardware designers must then analyze the code manually, figure out suitable hardware architectures for the code and re-write it using any Hardware Description language (HDL).

High level languages are programming languages used normally for software applications where designers do not have to worry about how this program will be executed as the compiler will take care of this. On the other hand, HDLs including VHDL and Verilog are low level languages where the designer needs to specify every detail from the registers used to the connectivity of the modules in order to create a hardware architecture.

In order to deal with quicker time to market cycles, it is preferable that high level languages have ability to describe hardware. However, high level languages per se are used for software programs and have no constructs needed for hardware designs. Therefore, high level languages have been extended to deal with hardware and subsets of the high level language extension which is derived from the original high level language have been created to describe hardware. The subsets incorporate new statements that allow users to specify features that are needed in hardware and but are not provided by common high level languages. The new statements introduced into the subsets include, for example, a statement for customizing a bit width and another statement for parallelism declaration.

The subsets of high level language extension also limit the use of some constructs, which do not have a direct translation in hardware or cannot be determined at compile time, e.g. pointers, dynamic memory allocation in case of C subsets, or are particularly difficult to translate, e.g. function calls, recursion, ‘goto’s and type casting. Some examples of C/C++ subsets are SystemC, BDL (Behavioral Description Language), HandleC or SA-C and JHDL (Just-Another Hardware Description Language) for Java.

Using the subsets of high level language extension simplifies the design process as designers do not need to deal with low level Hardware Description Languages (HDLs) such as VHDL or Verilog. However designers still have to manually perform the analysis of the system in order to generate suitable hardware architectures before they can start describing the architectures in any of high level language subsets. They need to analyze the system to specify, e.g. bit widths for every signal, and parallelism, bind the arithmetic operations to specific components, and define if any resources need to be shared.

In the related arts of the present invention, U.S. Pat. No. 6,968,517 [PL1] issued to McConaghy discloses a method of interactively determining at least one optimized design candidates using an optimizer which has a generation algorithm and an objective function.

In order to optimize the designed circuits, it is necessary to explore the design space. Such design space exploration may use data flow graphs. Typical parameters of the design space exploration are timing, power, and ares.

Ahmad et al. [NPL1] studied the tradeoffs between the control step and area in data flow graphs using genetic algorithms. Holzer et al. [NPL2] used a similar approach using an evolutionary multi-objective optimization approach to generate Pareto-optimal solutions. Habuelt et al. [NPL3] used Pareto-Front Arithmetics (PFA) to reduce the search space in embedded systems by decomposing a hierarchical search space.

As described above, the design space exploration for high level synthesis is important to accelerate the design of hardware bridging the gap between the initial high level language algorithmic description and the final hardware design. It also allow the exploration of the trade-offs of the different design parameters i.e. area, latency, throughput, power at the earliest possible design stage. The proposed method can be applied to system level design as well as on single and multiple processes exploration, although as an example during this work we will refer to single process design space exploration.

### SUMMARY OF THE INVENTION

### Problem to be Solved by the Invention

An object of the present invention is to provide a method of robust design space exploration for high level synthesis, which has been developed to bridge the gap between high level algorithmic descriptions and the final optimized hardware design given (or not) a set of the design constraints.

Another object of the present invention is to provide a system for a robust design space exploration tool for high level synthesis, which has been developed to bridge the gap between high level algorithmic descriptions and the final optimized hardware design given (or not) a set of the design constraints.

### Means for Solving the Problem

An exemplary aspect of the present invention is a method for automatically exploring a design space of an untimed high level language, including at least one of: (a) exploring automatically a set of local operations parsing an input source and assigning a set of attributes to each of the local operations; (b) exploring a set of global synthesis option that affects an entire design of a target circuit; and (c) exploring number and type of functional units allocated to the design.

Another exemplary aspect of the present invention is an apparatus for automatically exploring a design space of an untimed high level language, including: an input device for receiving inputs to automated exploration; a parse tree generator for generating a dependency parse tree based on a source code; an exploration device for at least one of (a) exploring automatically a set of local operations parsing an input source and assigning a set of attributes to each of the local operations, (b) exploring a set of global synthesis option that affects an entire design of a target circuit, and (c) exploring number and type of functional units allocated to the design; and an output device for delivering exploration results.

### BRIEF DESCRIPTION OF THE DRAWINGS

FIG. 1 is a process parse tree diagram illustrating the parsed tree generated by the design space exploration according to an exemplary embodiment of the present invention;

FIG. 2 is a general flow chart illustrating the entire processes of design space exploration according to the exemplary embodiment;

FIG. 3 is a view illustrating an example of the exploration inputs and data conversion;

FIG. 4 is a flow chart illustrating the detailed exploration operation;

FIG. 5 is a block diagram illustrating a design space exploration apparatus according to the exemplary embodiment;

FIG. 6 is illustrating an example of an overview of the input and outputs of the exploration;

FIGS. 7A and 7B are views each illustrating an example of clustering to reduce the runtime of the exploration;

FIGS. 8A to 8D are views illustrating an example of the full design space exploration steps;

FIG. 9 is a view illustrating the effect of the global cost function weights on the automatically generated designs;

FIG. 10 is a view illustrating an example of an interactive design space exploration window which is used for displaying and modifying the automatic generated design generated by the method according to the exemplary embodiment;

FIG. 11 is a view illustrating creation of smallest possible operation clusters that lead to a smaller exploration runtime in accordance with the exemplary embodiment; and

FIG. 12 is a view illustrating creation of largest possible operation clusters that lead to the fastest exploration runtime in accordance with the exemplary embodiment.

### DESCRIPTION OF EMBODIMENTS

Turning now descriptively to the attached drawings, in which similar reference characters denote similar elements throughout the several views, automatic generation of new hardware designs according to an exemplary embodiment of the present invention will be described.

The automatic generation of new designs is based on an automated design space exploration for high level language descriptions for high level synthesis, i.e. behavioral synthesis. Behavioral synthesis allows the creation of multitude hardware architecture for a unique untimed high level language description fast and with no or minor changes in the original source code by applying a set of global synthesis options, specifying the maximum number and type of functional units allowed and specifying local attributes specified as pragmas at specific operations (e.g. loops, functions, arrays).

In the following description, the exemplary automatic generation starts from the same source code of untimed high level language.

A given code of untimed high level language can be manually instrumented with pragmas, e.g. implement functions as inline expansion or ‘goto’ (i.e. jump to a specified block), loops (e.g. do not unroll, unroll x-times, unroll completely, or fold) and mapping arrays as wired logic, registers or memories. These pragmas usually have the following format:

/* pragma unroll=all */
for(x=0; x < 10; x++) ....

This example instructs the high level language to unroll the for loop completely.

The pragmas guide the high level synthesis tool in the synthesis of the given source code. The method according to the present exemplary embodiment reads a set of pragmas (i.e. attributes) specified by the user on an external library file or declared internally for a defined set of operations (e.g. for loops, functions, arrays) each with a given initial weight based on their biased contribution to reduce/increase, e.g. area, latency and power. The user can also define specific operations and its corresponding attributes as far as these are supported by the high level synthesis tool. Every operation to be explored can either be manually characterized by the user or automatically by the method of the present exemplary embodiment. In the following case only the two (2) assigned pragmas will be explored for the given operation:

/* Pragma explore1=“unroll=all, weight[A2:L8]”, explore2=“unroll=0,
weight[A10:L2]”, explore3=“unroll=(2-6), weight[A5:L5]” */
for(x=0; x < 10; x++) ....

In case no local pragmas are defined, the pragmas specified in the external library will be used. The initial weights are characterized based on the usual, intuitive behavior of these attributes. Intuitively, if a function is synthesized as a ‘goto’ it will reduce the total area compared to the inline case where every time the function is called a new hardware block is generated. This is nevertheless not always the case as in some cases the number of multiplexes inserted in order to share this function exceeds the savings obtained by implementing a function as a ‘goto.’ In case of small functions' bodies inlining could lead to better area/performance results.

Inline expansion is a method of expanding the function contents at all places where the function is being invoked. As the function contents are placed and expanded where invocation is done, the overall size of the description increases. This increase in description results in possible increase in the resultant hardware area. However, the execution cycle count of the synthesized circuit generally decreases as compared to the ‘goto’ conversion. The ‘goto’ conversion on the other hand is a synthesis method in which the processes of functions are consolidated into a single location. This consolidation is such that all the function process invocations are executed from this single location only. If the same function is to be invoked from multiple locations, consolidation of the processing to a single location leads to a smaller circuit area in comparison to inline expansion. However, as the invoking of the function requires one cycle for function call, this method tends to results in increased execution cycle count as compared to inline expansion.

In the following description, the above described step of the creation of a unique set of attributes for each explorable operation is defined as the first exploration step.

The weights are the actual probabilities of choosing this attribute to maximize a global cost function specified externally. If designs with low area wants to be generated the attributes with higher area weights should lead to smaller area designs have therefore a higher probability of being selected.

The method according to the present exemplary embodiment also uses a set of global synthesis options that apply to the entire design. e.g. what kind of scheduling policy is performed such as speculative scheduling, ASAP, ASAP scheduling of inputs and outputs, which optimization heuristic to be used during behavioral synthesis (e.g. area, latency, delay-oriented) and what kind of resource sharing policy, if any is applied. The global synthesis options provide coarser grained control over the design exploration. They can also map all operators identified in the parse tree generation to a specific attribute. In this case all operations will have the same attribute. This step for creating a set of global synthesis options for the set of attributes generated in the first exploration step is defined as the second exploration step.

The third exploration step involves exploration of the maximum number and type of FUs (functional units) (e.g. adders or multipliers) for the given attributes and synthesis options. This has a significant effect on the scheduler and therefore on the final design. The maximum number of the FUs will be modified dynamically during the exploration.

The fourth exploration step is clock step exploration and involves exploration of the clock period. This step influences the scheduling by allowing more ore less operations to be scheduled in the same control step and thus impacting the number of total states.

The four types of exploration steps can be performed together or in any sort of combination (e.g. only explore the local attributes; explore attributes and global synthesis, or explore three of the four types together). It should be noted that the fourth step is independent of the other steps and can be treated separately.

The method according to this exemplary embodiment also allows complete design space exploration by automatically modifying the global cost function (GCF) weights starting at lower area design, increasing gradually until lower latency designs are generated (or vice versa). A unique set of attributes, global synthesis options and the number and types of FUs is generated for each new design. Each new design is incrementally generated from the previous design based on the given Global Cost Function (GCF). The GCF is given by:

GCF=xA+yL+xP,

where the weight factors x, y and z represent the importance of minimizing the total area (A), total latency (L) of power (P), respectively. The weights are adaptively modified during the exploration in order to explore the entire design space. If x>>y and z, the attributes with highest minimizing area weights have a higher probability of being used. The If only one part of the design space wants to be explored the cost function will remain fixed exploring only designs around the given cost function. The randomness of the method allows the escape from local minima.

A unique set of attributes is generated for each new design by generating a unique hash index for each design's local attributes, global synthesis options and number and type of FUs used.

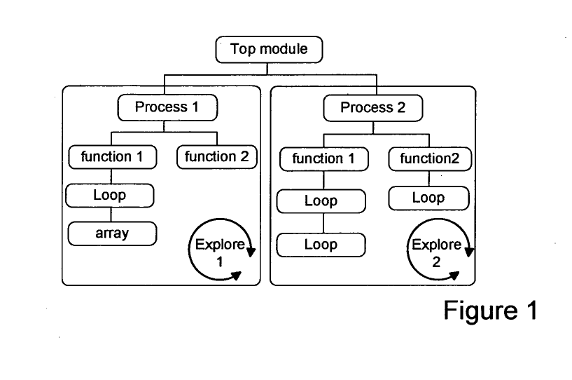

FIG. 1 illustrates an example of the parsed tree generated by the method of the exemplary embodiment. It is possible to extract all the operations that can be explored from FIG. 1. A dependency tree can be built from the extracted operations. Operators closer to the tree source have a higher impact on the final design as all the dependent operations will be, e.g., replicated or unrolled, depending the attribute mapped to this operation. The weight of each attribute is adjusted dynamically based on the position of each operator.

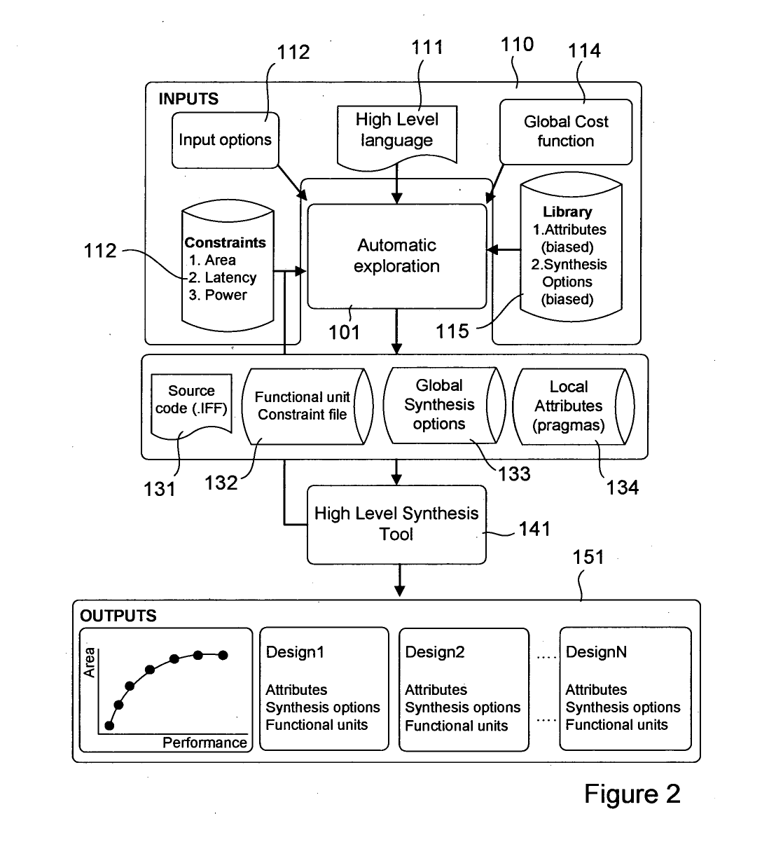

FIG. 2 illustrates the entire exploration flow, staring from the parsing of the high level language source code to build a parse tree. An example of the parse tree is shown in FIG. 1. Automatic exploration (block 101) builds the parse tree. The automatic exploration generates a new set of local attributes, global synthesis options and the functional unit constraint file for the high level synthesis tool. Inputs 110 to automatic exploration 101 comprise: high level language code 111 to be explored; input options 112, and global cost function (GCF) 114. Automatic exploration 101 also refers to: constraint file 112 containing a set of input constraints (e.g. area, latency and power), which are optional; and input library 115 with attributes and global synthesis options (biased or unbiased), and stores the exploration results into the output files. A user can specify the code, options, GCF, input constraints and input library. The output files from automatic exploration include source code file 131 (i.e. IFF file), functional unit constraint file 132, file 133 for the global synthesis options and file 134 for local attributes (progmas).

Then high level synthesis tool 141 refers to constraints file 112 and the output files of automatic exploration 101 and delivers, as output 151, several new designs and a graphical view representing exploration results. In FIG. 2, the new designs are indicated by “Design1”, “Design2”, . . . . In the present exemplary embodiment, the result of the high level synthesis is read back in order to extract the information of the new designs and it is checked if the constraints are met or if the new set of options causes an error in the synthesis.

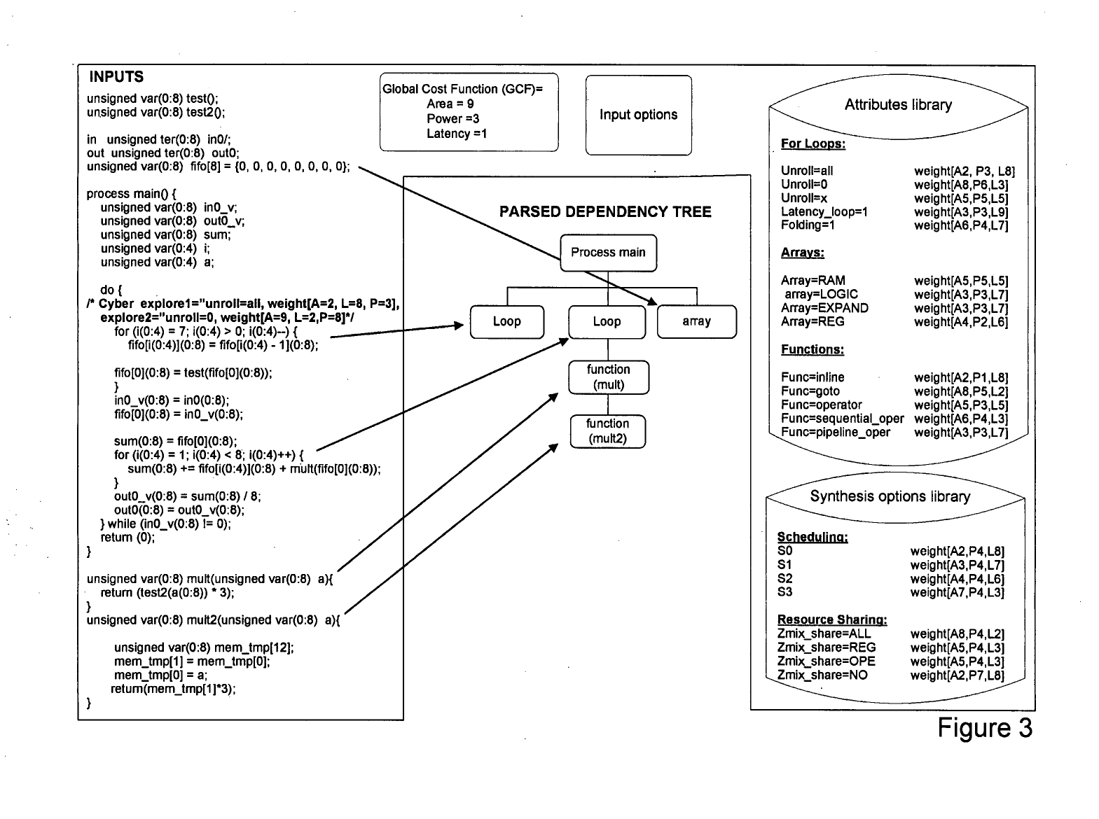

FIG. 3 illustrates an example of the detailed inputs to “Automatic exploration” block 101. An example of a high level language (e.g. BDL in this case) for hardware design shown with an example of the global cost function, input options, weighted list of attributes and synthesis options. The source code also illustrates the use of local attribute pragmas to limit the exploration of specific operations directly at the source code. The very first step of the exploration after reading all the inputs is to generated the dependency tree for only the explorable operations shown in the same picture.

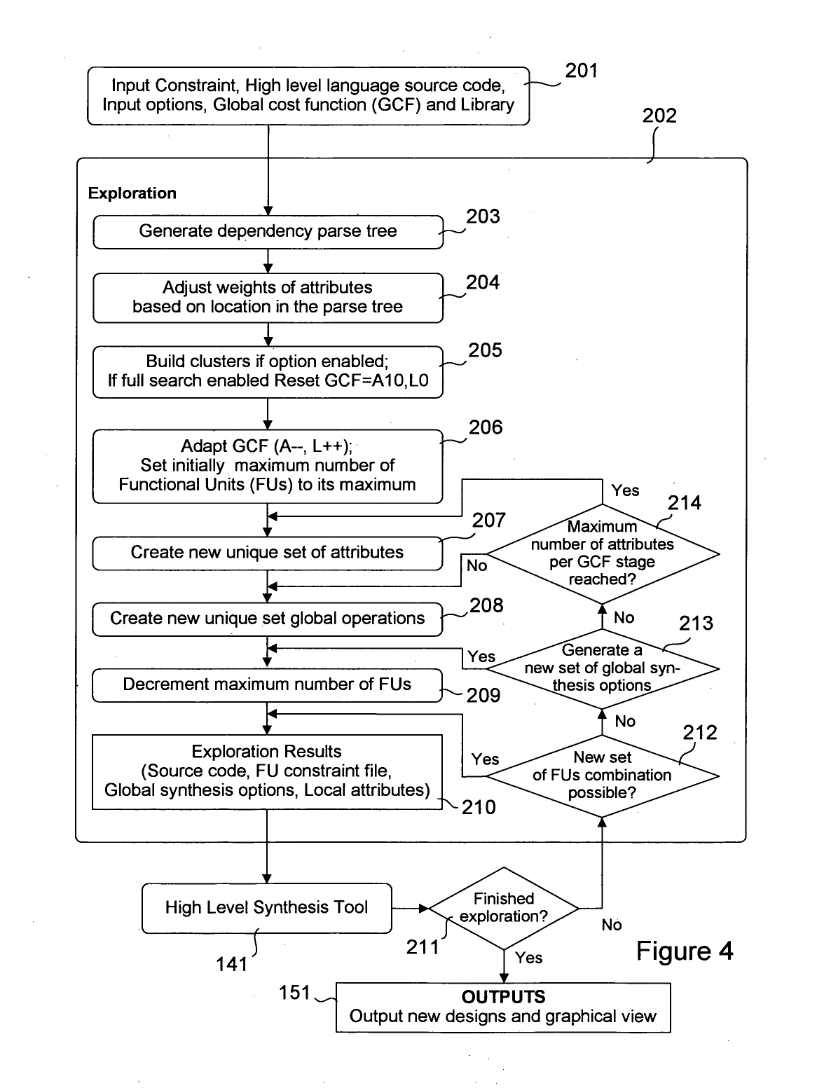

FIG. 4 illustrates the detailed flow chart of the exploration method and describes the main exploration steps, starting with all the inputs needed and going through all the main steps in the exploration procedure. FIG. 4 also shows the outputs generated.

First, inputs 100 to the automated exploration are read at box 201 and then sequence 202 for the exploration starts. The dependency parse tree is generated for the explorable operations at box 203, and weights of the attributes are adjusted based on the position of each operation in the parse tree, at box 204. After the adjustment, clusters are built if design exploration runtime is critical, at box 205. In case that full search is enabled, GCF may be reset to GCF=A10, L0, for example.

Next, global constraint function is adapted with decrementing A and incrementing L if global search is selected, at box 206. At the same time, the maximum number of the FUs is initially set to its maximum. A unique set of attributes is created at box 207 and a unique set of global synthesis options is created at box 208. Then, at box 209, the number of functional units for the given attributes and synthesis options are explored with decrementing the maximum number of the FUs. Results 210 of the exploration are then applied to high level synthesis tool 141.

According to the present exemplary embodiment, the above steps for exploration are repeated all synthesis options have been explored and iterated step until exit condition is met. When the exploration steps are continued, the GCF is adapted for each repetition. Therefore, the present exemplary embodiment has the following steps illustrated in boxes 211 to 214.

After the high level synthesis, it is determined whether exploration is finished or not at box 211. If the exploration is finished, then high level synthesis tool 141 delivers the several candidate new designs and the graphical view. Otherwise, it is determined, at box 212, whether a new set of combinations of FUs is possible or not. If the new set is possible, then the process goes to box 209. If the new set is not possible, then it is determined, at box 213, whether a new set of global synthesis options is to be generated or not. If so, the process goes to box 208 and otherwise, the process goes to box 214. At box 214, it is determined whether the maximum number of attributes per GCF stage is reached or not. If the maximum number is reached, the process goes to box 206 to adapt the GCF to continue the exploration, and otherwise, the process goes to 207.

After the all exploration is finished at box 211, the results are then investigated.

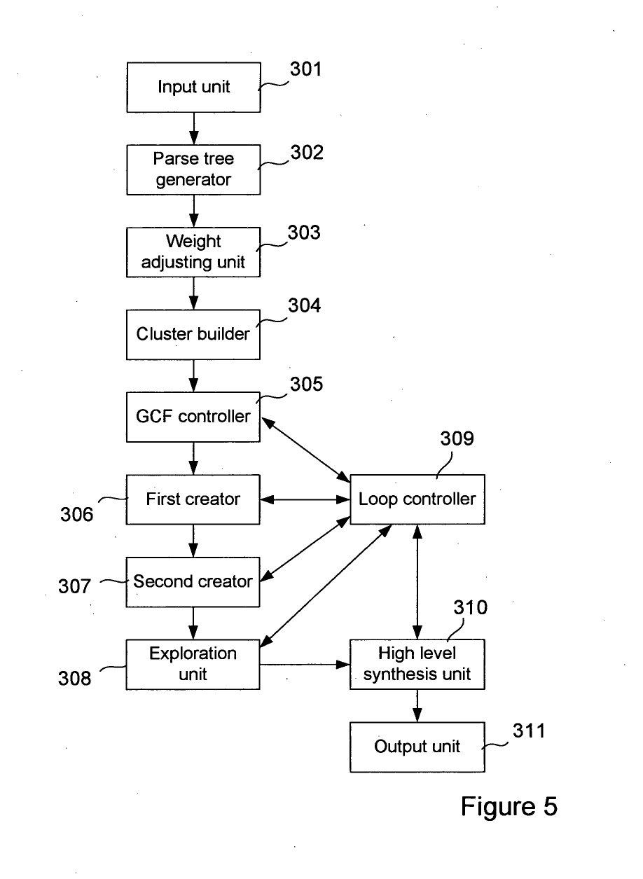

FIG. 5 illustrates the construction of a design space exploration apparatus which carries out the sequence of processes shown in FIG. 4.

The design space exploration apparatus includes: input unit 301 for receiving inputs 110 to the automated exploration; parse tree generator 302 for generating the dependency parse tree based on the source code; weight adjusting unit 303 for adjusting the weights of the attributes based on the position of each operation in the parse tree; cluster builder 304 for building the clusters; GCF controller 305 for adapting the global cost function; first creator 306 creating the unique set of attributes; second creator 307 for creating the unique set of global synthesis options; exploration unit 308 for exploring the number of functional units for the given attributes and synthesis options; loop controller 309 for setting and decrementing the maximum number of function units and controlling the loop operation of boxes 211 to 214 in FIG. 4; high level synthesis unit 310 which functions as high level synthesis tool 141 described above; and output unit 311 for delivering the new designs and graphical view representing exploration results.

The design space exploration apparatus described here can also be realized by allowing a computer such as a personal computer or a workstation to read a computer program for realizing the system and execute the program. The program for allowing the computer to functioning as a design space exploration apparatus is read to the computer through a computer-readable recording medium such as CD-ROM or over a network. The scope of the present invention also includes a program used to direct a computer to function as the design space exploration apparatus, and a program product or computer-readable recording medium storing the program.

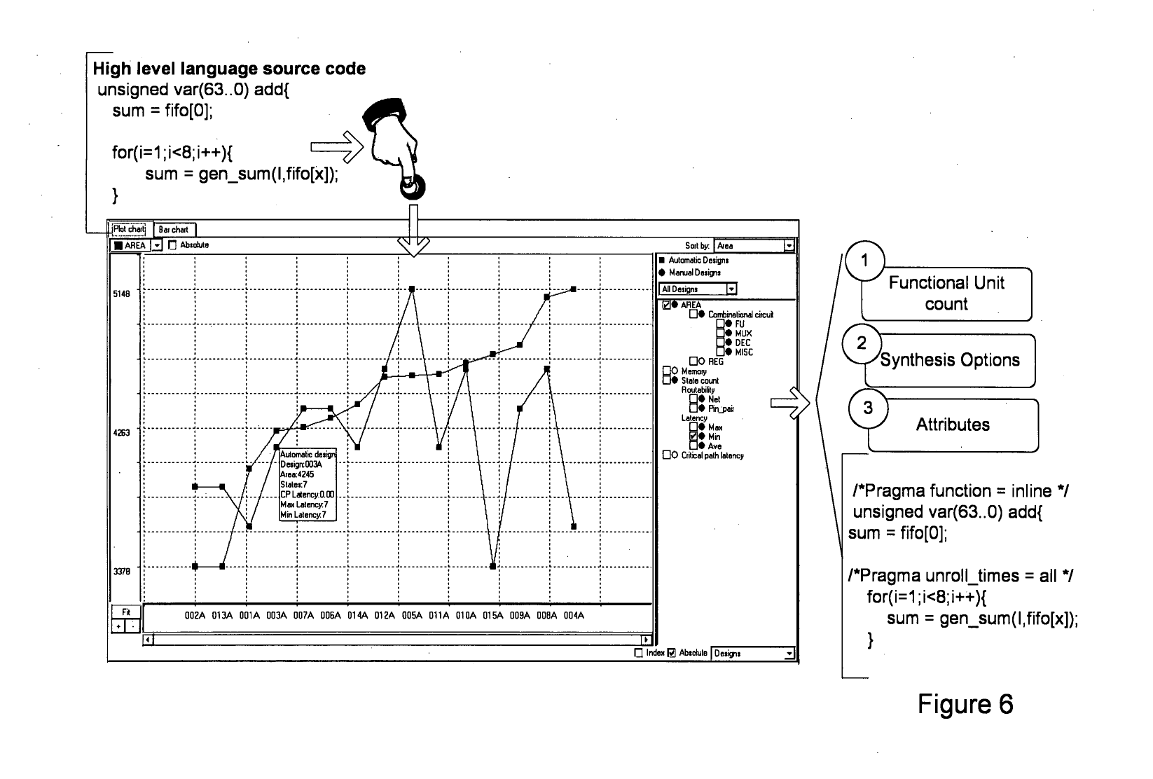

FIG. 6 illustrates an example of the overview of the input and outputs of the exploration. This figure represents an exemplary displayed screen on a display device of the design space exploration apparatus. The input is a high level language description that will be synthesized using any high level synthesis tool, and the output of the automatic exploration is the new set of local attributes, global synthesis options and number and type of functional units. The graph shown in FIG. 6 is a trade-off curve of all the generated designs. Each point is a new design and the x- and y-axis can represent different parameters based on the user selection. By clicking on the check boxes on the right pane, different design metrics can be displayed. e.g. area, latency, number of states, memory, registers.

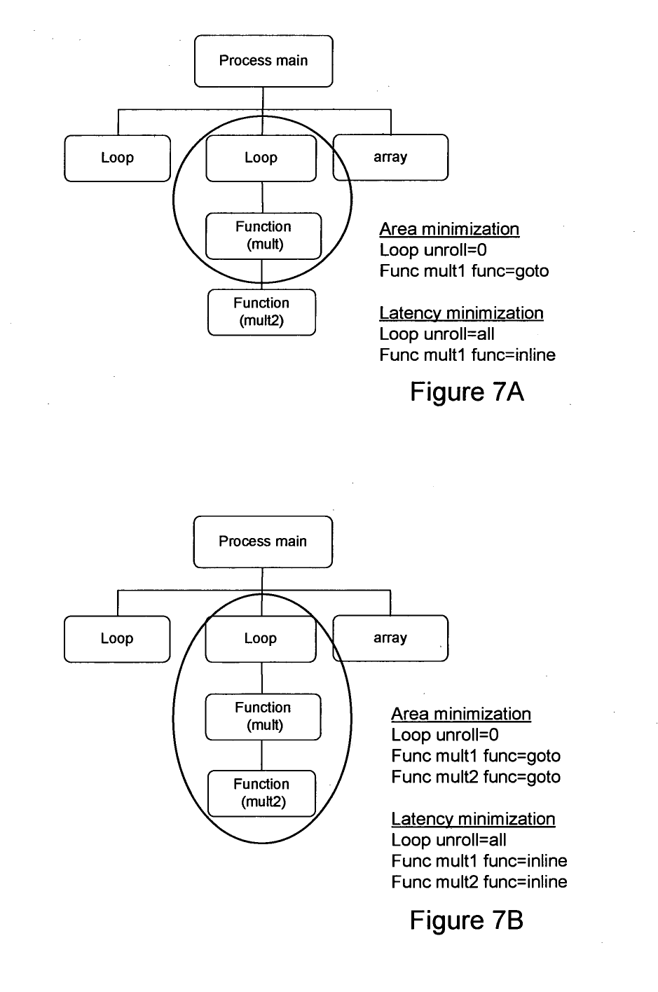

In order to reduce the runtime, the clustering described above can be applied. A set of explorable operations can be clustered and a fixed set of attributes are applied to them. FIGS. 7A and 7B show the clustering of the current example. There are two alternatives: FIG. 7A shows clustering which targets smallest possible clusters to reduce the design space, but allow higher explorability; and FIG. 7B shows building clusters as large as possible to reduce runtime as much as possible and assign fixed attributes to these based on the GCF. These fixed attributes can change if the GCF also changes.

In the example shown in FIGS. 7A and 7B, a fixed set of attributes are applied to the different clustered operations based on the GCF. If the target is to minimize area, the attributes that minimize area are used. In case that it is to minimize latency, a different set of attributes will be assigned to these operations. The clustering size will impact the design search space as larger clusters mean less explorable combinations. The drawback is that the optimum designs (i.e. smallest area and latency) might not be found. The fixed set of attributes is re-assigned to each cluster if the exploration GCF changes from, e.g. minimizing area to minimizing latency during the adaptive change of the GCF weights.

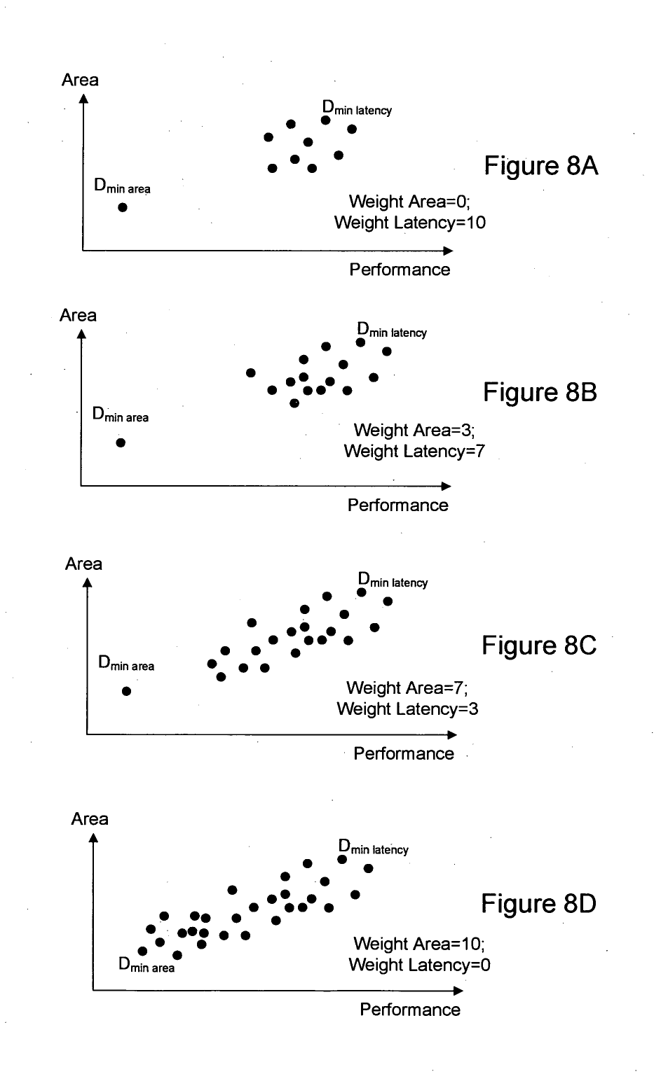

FIGS. 8A to 8D illustrate the full design space exploration step and sequentially show the results of the space exploration. As shown in FIG. 8A the full design space exploration starts with a global cost function that targets design with low latency. Then, as shown in FIGS. 8B to 8D, the cost function weights are adaptively modified in order to explore the entire design space until designs that that minimize area are generated when the cost functions weights are the highest for area minimization and lowest for latency minimization.

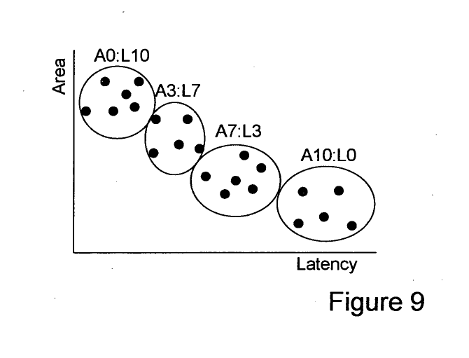

FIG. 9 illustrates the effect of the global cost function weights on the automatically generated designs. High area weight generates designs with lower area, while a high latency weight generates designs with low latency. Here, the ratio Ax:Ly indicates the weight. For example, A3:L7 indicates that the weight for area is 3 and the weight for latency is 7.

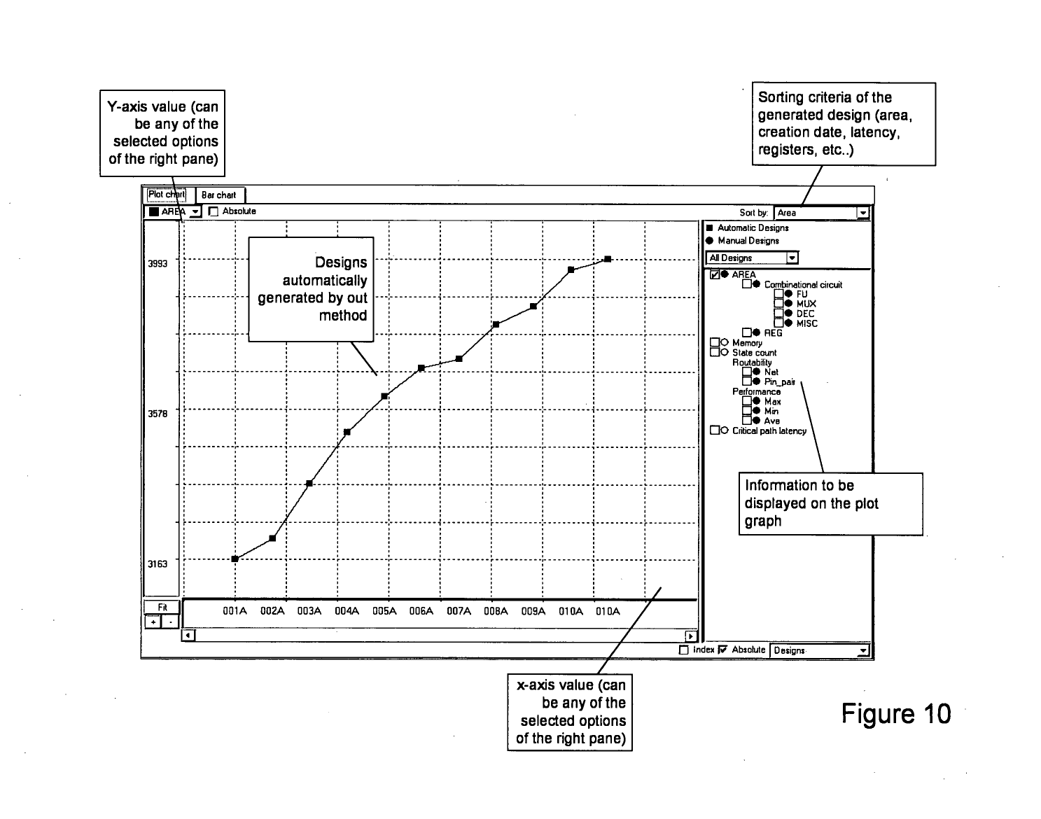

FIG. 10 illustrates an example of the interactive display of the automatic generated design according to the present exemplary embodiment. Once the exploration has finished, the designs are plotted in a sequence graph or bar chart where the trade-offs between the different designs can be easily analyzed. The values of X-axis and Y-axis can be modified by selecting the different values given in the combo-box to represent different options (e.g. area, latency, throughput, power, number of states, memory). This helps the designer explore the different trade-offs efficiently. By clicking on one of the designs, RTL code is generated automatically by the present exemplary embodiment.

Next, the generation or creation of clusters will be described. Here, two modes for exploration are defined: quick exploration mode and ultra quick explanation mode.

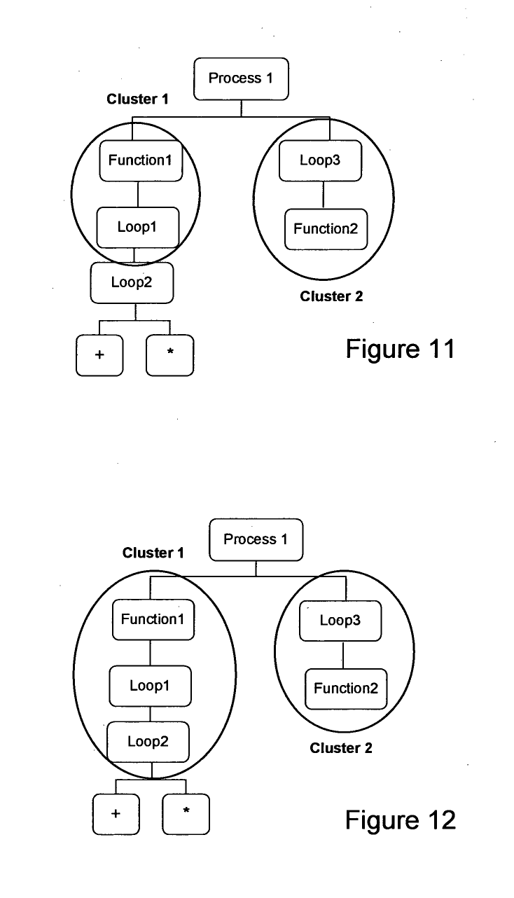

FIG. 11 illustrates the generation of clusters and corresponds to the quick exploration mode. These clusters are the smallest possible taken from the cluster library. This will reduce the design space considerably by fixing the clusters to specific attributes depending on the global cost function maximization target. In case of global design exploration search the attributes assigned to the clusters will change depending on the global cost function maximization target.

FIG. 12 illustrates the generation of the largest as possible clusters and corresponds to the ultra quick explanation mode. Generating largest clusters will reduce the design space even further, but might oversee some optimal designs.

### EXAMPLES

Next, the exemplary embodiment will now be described in greater detail in the context of an example. It is assumed that the inputs shown in FIG. 3 are applied to the automated exploration. In this example, the problem definition consists of two goals: (1) generating the designs that minimize the cost function (e.g. smallest design and design with the smallest latency); and (2) exploring the combination of attributes, global synthesis options and number of functional units in order to allow the user to analyze the different trade offs. These two results might seem contradicting as the latter involves generating as many as possible different combinations, while the first involves generating the least possible designs. Nevertheless the present exemplary embodiment can target both goals. The first is achieved by specifying a fixed GCF and exploring designs around it, and the latter is achieved by specifying a full search. In this case, the search will adaptively modify the GCF weights to explore the entire search space.

The method does also analyze each explored design resolving conflicting objectives minimization by finding the optimal points for the different objective functions. These points are called Pareto point. The method described here can also be targeted to find all the designs at the efficient frontier (also called Pareto frontier or Pareto front).

FIG. 3 shows an example of the inputs specified by the user in detail. The inputs are: (1) the high level language source code for hardware design, which in this case is BDL; (2) the global cost function weights; (3) the attributes with their initial weights; and (4) the global synthesis options with their weights. The user can also specify some options in an option file in order to specify: (a) how long the exploration should run, in multiple forms, e.g. either time or number of designs, but not restricted to these; (b) if the entire search space wants to be explored or only the design space specified by the given GCF; and (c) any attributes or synthesis options to be ignored during the exploration. These are only some example of controllability options, but can include any other option that can control the exploration.

The source code is parsed and a dependency tree is generated. This is important because the impact of an attribute applied to the same type of operations will be different based on the position of the operation in the parsed tree, e.g. in case of nested loops, unrolling the outer loop will impact area and latency more then unrolling the most inner loop. In this case, unrolling the loop with function calls will impact the area more than the second loop. The weights of the attribute options are therefore adjusted based on the position of the operation. This automatic weight adaption can be enabled or disabled in the input option file.

Once this data structure is generated, the main exploration loop starts. There are two options. The first option is “run the exploration for the given fixed GCF”. The exit condition can be any one of: a time limit; a number of designs; run until no new design is generated; and exit after a specified number of designs are generated that do not improve any previously generated. In this case, designs that maximize the given GCF are generated. The second case performs a complete design space search. In this case, the GCF weights are initialized so that the first designs will minimize area. During each iteration, the GCF weights are updated until the final results generate designs that minimize latency.

Four types of explorations can be performed: (a) exploration of the attributes; (b) global synthesis options; (c) number and type of functional units (d) clock period. Any one of four types can be explored. Alternatively, any combination of two, three or four of the types can also be explored.

In case three options want to be explored, the flow is as shown in FIG. 4. A new unique set of attributes are generated. Then a new set of global synthesis options and lastly, the number of functional units (FUs) are generated. The number of FUs is explored using diverse algorithms like binary search, but not limited. The last FUs exploration ends with the least possible number of FUs. Once the FUs exploration has finished, the global synthesis options are re-generated to study the effect of these of the fixed set of attributes and the number of FUs is re-explored. The entire iteration is repeated until the global synthesis options have been completely explored. Once the exploration has finishes, a new set of attributes is again generated and the entire iteration is repeated. After the specified exit criteria is reached, the global cost function is either adapted or the exploration ends.

In the above explanation, there are three main steps in the exploration (i.e., attribute generation, global synthesis options, and FUs exploration). In addition to them, the cluster formation described above can be performed. The cluster formation is an option to speed up the exploration at the expense of missing some optimal designs. The clustering does only work with the attribute exploration. In other words, the clustering is basically an option of the attribute exploration. Further, the above-described fourth step, i.e. clock step exploration, can be performed.

The exploration generates the unique set of attributes, synthesis options and number of used FUs for each generated design. The format of the results the exploration will vary depending on the high level synthesis tool. The results can then be visualized as shown in FIG. 10, for example, where the designer can easily explore the different design trade-offs.

FIG. 3 shows an example of the high level language source code where the first loop has some manual attributes associated to it. This indicates that only those attributes will be explored for that loop. In case of the second loop, all the attributes specified in the attribute library will be considered during the exploration.

As described above, the present exemplary embodiment provides a microarchitectural design space exploration technique for behavioral descriptions targeted for hardware designs. A series of unique hardware architectures are automatically generated given (or not) a set constraints (e.g. area, latency, critical path, power) from a unique untimed high level language description. The design space will be searched generating automatically different designs that maximize each of the constraints. The results are presented to the designers in multiple ways for an easy way to analyze the trade-offs between the different designs.

The above-described exemplary embodiments of the present invention are intended to be examples only. The present invention has been discussed in the context of high level synthesis, but could also apply to other areas of EDA such as register transfer level (RTL) or digital systems. In addition, it is fully contemplated that the method of the present invention can have broader applications outside these examples. For example, the designer could run an initial exploration. Once the exploration is finished, the designer can visualize the results and modify the input options, attributes or global synthesis option weights, and continue running the exploration. As each design registers the unique set of attributes, global synthesis options and FU in a log file, a new combination of these is ensured when the design is re-run.

As the exploration can take a long time to run, it has been prepared to run on a single processor, or multiprocessor to accelerate the exploration. The designer can pause and resume the exploration anytime, stop it and continue later as well as leave it running during multiple days. The designer can anytime see the results of the exploration and if satisfied with the results stop it.

Although the present invention is presented in the context of circuit design, for example, the method of the present invention is applicable to many other types of design problems including, for example, design problems relating to digital circuits, scheduling, chemical processing, control systems, neuronal networks, verification and validation methods, regression modeling, unknown systems, communications networks, optical circuits, sensors. The method of the present invention is also applicable to flow network design problems such as road systems, waterways and other large scale physical networks, optics, mechanical components and opto-electrical components.

Although the foregoing exemplary embodiment of the present invention has been described in some detail for purposes of clarity of understanding, it will be apparent that certain changes and modifications may be practiced within the scope of the appended claims. Accordingly, the present exemplary embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### CITATION LIST

### Patent Literatures

PL1: U.S. Pat. No. 6,968,517

### Non-Patent Literatures

NPL1: I. Ahmad, M. Dhodhi and F. Hielscher, “Design-Space Exploration for High-Level Synthesis,” Computers and Communications, pp. 491-496, 1994.
NPL2: M. Holzer, B. Knerr and M. Rupp, “Design Space Exploration with Evolutionary Multi-Objective Optimisation,” Proc. Industrial Embedded Systems, pp. 125-133, 2007.
NPL3: C. Haubelt and J. Teich, “Accelerating Design Space Exploration,” International Conference on ASIC, pp. 79-84, 2003.

1. A method for automatically exploring a design space of an untimed high level language, comprising at least one of:
(a) exploring automatically a set of local operations parsing an input source and assigning a set of attributes to each of the local operations;
(b) exploring a set of global synthesis option that affects an entire design of a target circuit; and
(c) exploring number and type of functional units allocated to the design.

2. The method according to claim 1, further comprising:
generation of a dependency parse tree of an untimed original source code of all operations that have explorable attributes.

3. The method according to claim 1, further comprising:
automatic biasing of each attribute specified by the user externally or internally declared depending on each operations natural tendency to reduce area, latency and power;
automatic adjustment of the weights based on a position of the operation in the dependency parse tree; and
mapping of the attribute weights to the actual probability of choosing the relevant attributes to lead to minimization of the global cost function specified by the user.

4. The method according to claim 1, further comprising:
dynamically adjusting the weights of the attributes based on a position of the operation in the dependency parse tree.

5. The method according to claim 1, further comprising:
generation of a unique hash index for each new design generated based on local attributes, global synthesis options and number and types of functional units used so that each generated design is unique.

6. The method according to claim 1, further comprising:
recording any synthesis errors due to the assignment of illegal attributes, synthesis options or any combination in order to avoid the error happening again during the given exploration or if the exploration is re-run.

7. The method according to claim 1, further comprising:
registering all the generated design in an external library with each designs unique hash index so that the exploration can be stopped and continued reading the unique key insuring that the same design will not be regenerated.

8. The method according to claim 1, further comprising:
adaptive modification of the global cost function weights in order to perform a full design space exploration.

9. The method according to claim 8, wherein the adaptive modification starts from low area designs with a higher area weight so that the probability of using attributes that lead to a small area design is higher, and ends with a high latency weight having a higher probability of choosing attributes and global synthesis options that will lead to smaller latency designs.

10. The method according to claim 1, wherein the option specifies the timeout after which either a single design exploration will be terminated or the entire exploration.

11. The method according to claim 1, wherein the option specifies a set of attributes to be explored as pragmas directly at the untimed high level language source code, and
only the given attributes will be used for the given operation and the weight are the probability of each attribute to reduce area/latency, which can be specified as an option.

12. The method according to claim 1, further comprising:
generation of different granularities of clusters to which a fixed set of attributes are assigned based on the global cost function,
wherein different granularities control the number of attribute combination reducing the design space, while larger clusters can lead faster design space, but might fail to detect the optimal designs.
the cluster attributes can change if the global cost function maximizing target changes.

13. The method according to claim 1, wherein
the option specifies when to exit the exploration, and
after a given number of designs, if no new design that improves the previous design could be generated, the exploration will finish.

14. The method according to claim 13, wherein the exploration can be re-run generated a new unique set of designs with no duplicated designs.

15. A method for automatically exploring a design space of an untimed high level language, comprising:
an operation in which specification of a global cost function where weights of different exploration targets are actual probabilities of choosing a local attribute and global synthesis options to minimize the global cost function; and
an exploration based on the given global cost function or the complete search space exploration adaptively modifying the global cost function weights.

16. An apparatus for automatically exploring a design space of an untimed high level language, comprising:
an input device for receiving inputs to automated exploration;
a parse tree generator for generating a dependency parse tree based on a source code; and
an exploration device for at least one of (a) exploring automatically a set of local operations parsing an input source and assigning a set of attributes to each of the local operations, (b) exploring a set of global synthesis option that affects an entire design of a target circuit, and (c) exploring number and type of functional units allocated to the design; and
an output device for delivering exploration results.

17. The apparatus according to claim 16, further comprising a high level synthesis unit for performing high level synthesis based on the results of the exploration, wherein the output device delivers new designs generated by the high level synthesis unit.

18. The apparatus according to claim 16 further comprising a cluster generator for generating different granularities of clusters to which a fixed set of attributes are assigned based on a global cost function.

19. A computer program which causes a computer performing at least one operations of:
(a) exploring automatically a set of local operations parsing an input source and assigning a set of attributes to each of the local operations;
(b) exploring a set of global synthesis option that affects an entire design of a target circuit; and
(c) exploring number and type of functional units allocated to the design.
